(19) United States
(12) Patent Application Publication
(10) Pub. No.: US 2026/0086053 A1
(43) Pub. Date: Mar. 26, 2026

(54) Specimen Analysis Device

(71) Applicant: Hitachi High-Tech Corporation, Minato-ku, Tokyo (JP)

(72) Inventors: Tadao YABUHARA, Tokyo (JP); Jin MATSUMURA, Tokyo (JP)

(21) Appl. No.: 19/111,042

(22) PCT Filed: Sep. 14, 2022
(86) PCT No.: PCT/JP2022/034309

§ 371 Date: Mar. 12, 2025

(51) Int. Cl. G01N 25/02

(52) U.S. Cl. CPC G01N 25/02

(57) ABSTRACT

The purpose of the present invention is to uniformly suppress dew condensation in each housing chamber when multiple housing chambers each house a specimen container. The specimen analysis device according to the present invention comprises two or more openings, wherein warm air is supplied from each of the openings to each housing chamber, and the volume of the air supplied from each of the openings is uniformed by a first air volume adjusting material (see FIG. 2).

### TECHNICAL FIELD

The present invention relates to a specimen analysis device that analyzes a specimen.

### BACKGROUND ART

In a medical research institute, a hospital, or the like, a culture state of cells or bacteria is inspected based on a turbidity of a specimen including cells or bacteria. In the cell culture or the bacteria culture, a microwell plate, a culture dish, or the like is used as a specimen container. A pre-treated specimen, nutrient, or the like is dispensed or applied into a specimen container, and the specimen is cultured (for example, in an environment of 35° C.). Regarding the specimen in the specimen container, culture and observation are repeated for a long period of time to quantify a change in the shape of the specimen during the observation through image analysis or based on a turbidity, and the result is output according to a quantitative value thereof or the amount of change over time.

In this inspection, the specimen container is provided in the device for a long period of time. The inside of the specimen container enters a saturated state due to evaporation of a culture solution or the like. Therefore, dew condensation is likely to occur on a boundary surface between the specimen container and a specimen container lid. In an inspection device (transmission observation) that optically observes the specimen in the specimen container from the outside of the specimen container, when dew condensation occurs on a transmission member surface such as a lid of a specimen container upper surface that is interposed, refraction of light occurs, which leads to deterioration in contrast and a decrease in light intensity. In addition, it is difficult to accurately observe a change in the state of the specimen, which leads to erroneous determination of the measurement result.

PTL 1 describes a temperature control when a specimen is observed using a microscope. PTL 1 discloses a technique of blowing warm air to an observation tray upper portion to prevent occurrence of dew condensation on an observation tray lid inner surface.

### CITATION LIST

### Patent Literature

PTL 1: JP4116780B

### SUMMARY OF INVENTION

### Technical Problem

A specimen analysis device places a specimen container accommodating a specimen (cells, bacteria, or the like) on each of a plurality of housing chambers, and regularly observes the specimen while culturing the specimen. When dew condensation occurs in a lid of the specimen container, the light intensity of observation light is likely to decrease due to the dew condensation such that the measurement accuracy may decrease. Accordingly, a mechanism for preventing dew condensation is required. For example, as in PTL 1, the supply of warm air to the specimen container is considered.

However, when the effect of the warm air on each of the housing chambers varies, the effect of suppressing dew condensation also varies depending on each of the housing chambers. Due to this variation, a variation in the measurement result depending on each of the housing chambers is likely to occur.

The present invention has been made in consideration of the above-described problems, and an object thereof is to uniformly suppress dew condensation in each of a plurality of housing chambers in a specimen analysis device where each of the housing chambers houses a specimen container.

### Solution to Problem

A specimen analysis device according to the present invention includes two or more openings from which warm air is supplied to each housing chamber, and the air volume of the warm air supplied from each of the openings is uniformed by a first air volume adjusting material.

### Advantageous Effects of Invention

In the specimen analysis device according to the present invention, it is possible to uniformly suppress dew condensation in each of a plurality of housing chambers when each of the housing chambers houses a specimen container. The other configurations, tasks, effects, and the like of the present invention will be clarified from the description of the following embodiments.

### BRIEF DESCRIPTION OF DRAWINGS

FIG. 1 is a schematic diagram illustrating an overall configuration of an analysis device 0001 according to a first embodiment.

FIG. 2 illustrates a configuration example of a housing section 0003.

FIG. 3 illustrates a shape example of an air volume adjusting material 2106 and an outlet 2111.

FIG. 4 illustrates another configuration example of the air volume adjusting material 2106.

FIG. 5 illustrates a configuration example of the housing section 0003 in the analysis device 0001 according to a second embodiment.

FIG. 6 illustrates another configuration example of the housing section 0003.

FIG. 7 illustrates another configuration example of the housing section 0003.

FIG. 8 illustrates another configuration example of the housing section 0003.

FIG. 9 illustrates another configuration example of the housing section 0003.

FIG. 10 illustrates another configuration example of the housing section 0003.

FIG. 11 is a flowchart illustrating a procedure where an arithmetic section 11 controls a temperature of each of sections in the analysis device 0001.

FIG. 12 is a flowchart illustrating a procedure where the arithmetic section 11 controls a temperature of each of sections in the analysis device 0001.

### DESCRIPTION OF EMBODIMENTS

### First Embodiment

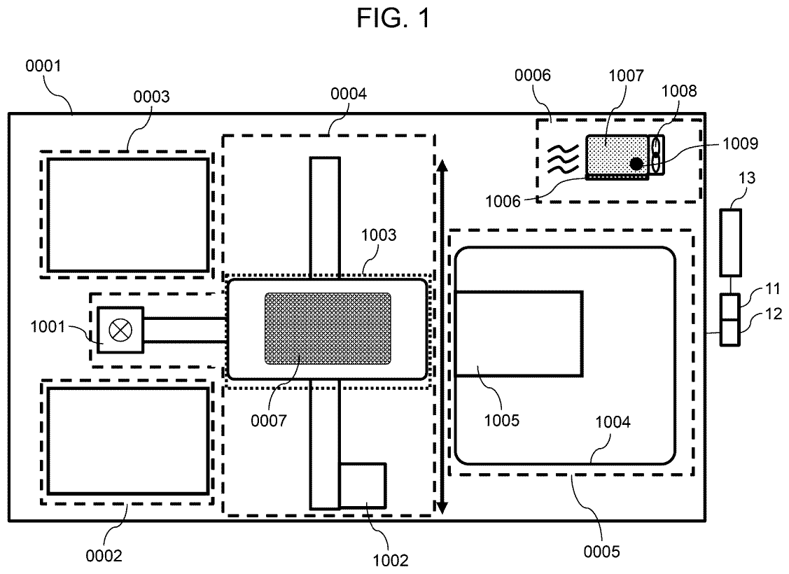

FIG. 1 is a schematic diagram illustrating an overall configuration of an analysis device 0001 according to a first embodiment of the present invention. The analysis device 0001 includes a loading/unloading section 0002, a housing section 0003, a transport section 0004, a detection section 0005, and a temperature control section 0006. An arithmetic section 11, a storage section 12, and a monitor 13 can be provided outside the analysis device 0001 or can be provided inside the analysis device 0001.

In the loading/unloading section 0002, a user can load and unload a specimen container 0007 through a door (not shown). The specimen container 0007 includes two components including a specimen container lower portion 2108 and a specimen container lid 2109 described below. The specimen container lower portion 2108 is a container including a plurality of wells such as 96 wells or 384 wells, and a specimen 2110 is taken in each of the wells. Examples of the specimen include a biological specimen such as a cell, blood, urine, a bacterium, or a piece of tissue. The specimen container lid 2109 may have a seal shape, or the specimen container lower portion 2108 may be a single well.

The housing section 0003 includes plural stages of specimen container housing chambers 2003 each of which houses the specimen container 0007. The analysis device 0001 may include a plurality of housing sections 0003. The details of the housing section 0003 will be described below.

The transport section 0004 includes an actuator 1001, an actuator 1002, a specimen container holding section 1003, and a ball screw or a belt mechanism (not illustrated). The specimen container holding section 1003 is moved by the actuator 1001 in the vertical direction through the ball screw or the belt mechanism, and is moved in a depth direction by the actuator 1002. The specimen container holding section 1003 can receive and deliver the specimen container 0007 from the loading/unloading section 0002, the housing section 0003, and a measurement section 1005.

In the detection section 0005, the measurement section 1005 in a measurement unit 1004 receives the specimen container 0007 from the specimen container holding section 1003, and measures a culture state of the specimen in each of the wells of the specimen container 0007. Examples of the measurement method include turbidity measurement, absorbance measurement, fluorescence measurement, and image analysis.

The temperature control section 0006 includes a heat source 1006, a heat sink 1007, and a fan 1008. Heat of the heat source 1006 through the heat sink 1007 is supplied into the device through air from the fan 1008. As the heat source, a heater, a Peltier element, or the like is used to increase or decrease the temperature in the analysis device 0001. As the heat sink (heat dissipator), aluminum, copper, iron, stainless steel, or the like can be used. The temperature control section 0006 has a function of warming the entire analysis device 0001 such that dew condensation described below does not occur when the specimen container 0007 is taken out from the housing section 0003.

When the analysis device 0001 starts, the user can provide the specimen container 0007 in the loading/unloading section 0002. After being provided, the specimen container 0007 of the loading/unloading section 0002 is transported to the measurement section 1005 of the measurement unit 1004 through the transport section 0004. The measurement section 1005 measures the culture state of the specimen 2110 in the specimen container 0007. After the measurement, the specimen container 0007 is transported to the housing section 0003 through the transport section 0004. A measurement cycle of the specimen is repeated for about 18 hours, for example, at intervals of 20 to 30 minutes. The analysis device 0001 transmits the amount of change over time in the culture state of the specimen to the arithmetic section 11. The arithmetic section 11 outputs the measurement result estimated from the amount of change to the monitor 13 or the like. After completion of the measurement, the specimen container 0007 is unloaded to the loading/unloading section 0002 through the transport section 0004. In the present embodiment, the user provides the specimen container 0007 in the loading/unloading section 0002. However, a structure where the user provides the specimen container 0007 in the housing section 0003 may be adopted instead of providing the loading/unloading section 0002.

As described above, the specimen container 0007 includes the specimen container lower portion 2108 and the specimen container lid 2109. The specimen 2110 is taken in each of the wells of the specimen container lower portion 2108. In a case where the specimen container 0007 is provided in the housing section 0003, when thermal energy supplied to the specimen 2110 in the specimen container lower portion 2108 from a material, air, and the like of a lower surface of the specimen container lower portion 2108 is higher than thermal energy supplied to the specimen container lid 2109, dew condensation occurs on a boundary surface between the specimen container lower portion 2108 and the specimen container lid 2109.

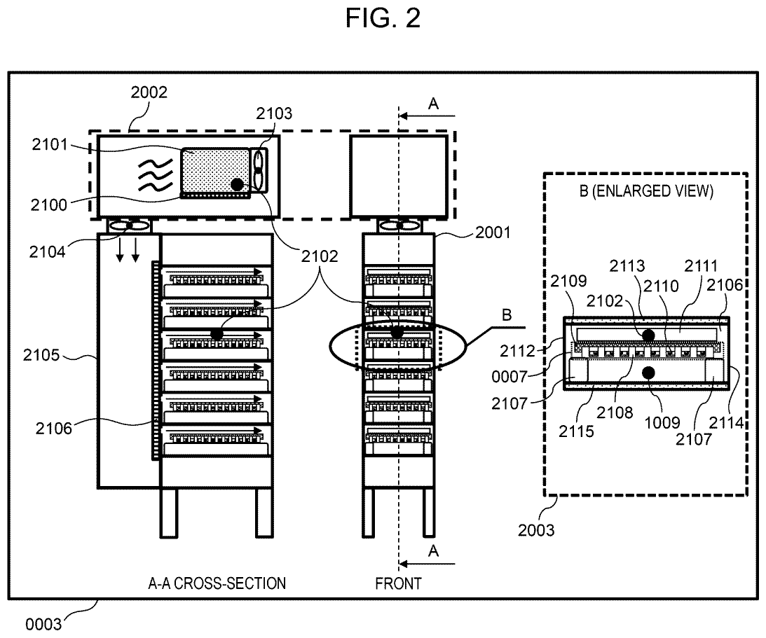

FIG. 2 illustrates a configuration example of the housing section 0003. The housing section 0003 includes a housing unit 2001 and a temperature control section 2002. The housing unit 2001 includes the specimen container housing chamber 2003, a fan 2104, a duct 2105, and an air volume adjusting material 2106. The housing section 0003 includes plural stages of specimen container housing chambers 2003, and each of the specimen container housing chambers 2003 houses the specimen container 0007. In the drawing, the number of stages of the specimen container housing chambers 2003 is six. However, the number of the stages is not limited to this example and may be increased or decreased, and the housing chambers may be arranged in the horizontal direction.

The specimen container housing chamber 2003 is surrounded by a heat insulating material 2107, the air volume adjusting material 2106, a side-surface metal material 2112, an upper-surface metal material 2113, a side-surface metal material 2114, and a lower-surface metal material 2115. The specimen container 0007 is placed on the heat insulating material 2107. The air volume adjusting material 2106 includes an outlet 2111. Instead of providing the heat insulating material 2107, a structure where the specimen container 0007 is provided on the metal material 2115 may be adopted. Examples of the metal material include aluminum, stainless steel, copper, iron, and titanium. Examples of the heat insulating material include glass wool, cellulose fiber, an insulation board, a wool heat insulating material, rock wool, rigid urethane foam, bead polystyrene foam, and phenol foam, but the heat insulating material is not limited thereto. A resin may be used as the heat insulating material. Examples of the resin include nylon, POM, PEEK, PPS, PTFE, PVC, PE, PP, PS, and ABS, but the resin is not limited thereto.

The temperature control section 2002 includes a heat source 2100, a heat sink 2101, a temperature sensor 2102, and a fan 2103. Heat of the heat source 2100 through the heat sink 2101 is supplied into the housing unit 2001 through air from the fan 2103. As the heat source 2100, a heater, a Peltier element, or the like can be used. The temperature sensor 2102 attached to the heat sink 2101 controls heating or cooling. As the heat sink (heat dissipator or heat dissipation plate), aluminum, copper, iron, stainless steel, or the like can be used. A thermistor, a platinum resistor, an IC chip, a thermocouple, or the like may be used as the temperature sensor 2102, and an installation location thereof may be an installation space of the temperature control section, the inside of the duct 2105, or the like in addition to the heat sink 2101. A temperature of warm air supplied by the temperature control section 2002 is higher than a temperature of warm air supplied by the temperature control section 0006.

The warm air heated by the temperature control section 2002 is supplied into the duct 2105 through the fan 2104. The warm air supplied into the duct 2105 is supplied onto the specimen container lid 2109 through the outlet 2111 of the air volume adjusting material 2106 in the specimen container housing chamber 2003. As a result, “the temperature of the specimen container lid 2109>the temperature of the specimen container lower portion 2108” is satisfied, and dew condensation on the boundary surface between the specimen container lower portion 2108 and the specimen container lid 2109 is prevented. In order to more efficiently supply the warm air to the specimen container lid 2109, it is desirable to provide the outlet 2111 above the specimen container lid 2109.

It is desirable that the warm air supplied from the duct 2105 in each of the stages is not supplied from a direction of the specimen container lower portion of each of the stages. Alternatively, a relationship “an air volume of an upper portion of the specimen container 0007>an air volume of a lower portion thereof≥0” may be satisfied to satisfy “the temperature of the specimen container lid 2109>the temperature of the specimen container lower portion 2108”. The warm air may flow from the upper portion to the lower portion of the specimen container. In this case, the warm air passes through the upper portion such that the temperature of the specimen container lid 2109>the temperature of the specimen container lower portion 2108 is satisfied.

It is preferable that a position of a temperature sensor 1009 that controls the temperature control section 0006 is a position where a temperature of the specimen container lower portion 2108 or a space in the vicinity thereof can be relatively measured. In addition, as long as the correlation with the temperature of the specimen container lower portion 2108 in the housing section can be obtained, the temperature sensor 1009 may be positioned at any position. For example, the temperature sensor 1009 may be positioned in the heat sink 1007 or in the vicinity of the specimen container lower portion 2108. The position of the temperature sensor 1009 or the number thereof is not limited.

It is preferable that a position of the temperature sensor 2102 that controls the temperature control section 2002 is a position where a temperature of the specimen container lid 2109 or a space in the vicinity thereof can be relatively measured. In addition, as long as the correlation with the temperature of the specimen container lid 2109 in the housing section can be obtained, the temperature sensor 2102 may be positioned at any position. For example, the temperature sensor 2102 may be positioned in the heat sink 2101 or in the vicinity of the specimen container lid 2109. The temperature sensor 2102 may be positioned in the temperature control section 2002, in a duct 2116 (described below), in the duct 2105, in a space in the vicinity of a heat insulating material 2119 (described below), or the like. The position of the temperature sensor 2102 or the number thereof is not limited.

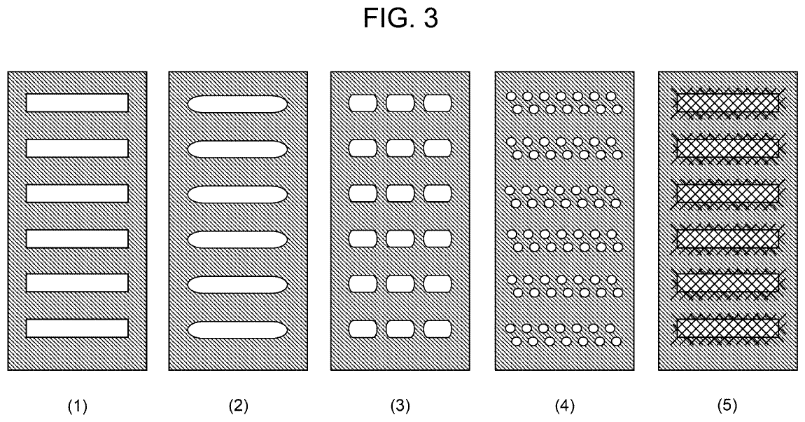

FIG. 3 illustrates a shape example of the air volume adjusting material 2106 and the outlet 2111. In order to uniformly supply the warm air from the upper stage to the lower stage of the specimen container housing chamber 2003, the air volume adjusting material 2106 includes the outlet 2111. The outlet 2111 may be an angle hole, a hole of an ellipse, a circle, or the like, a porous hole, or the like. That is, the shape of the outlet 2111 is not limited as long as the air volume flowing to the housing chamber can be controlled. The air volume blown from the outlet 2111 of the lower stage and the air volume blown from the outlet 2111 of the upper stage are made uniform by the air volume adjusting material 2106 such that the amount of evaporation of the specimen 2110 in the specimen container 0007 provided in the specimen container housing chamber 2003 is uniform across the upper stage to the lower stage (a variation in the amount of evaporation is suppressed). By suppressing the variation in the amount of evaporation, a change in the concentration of a culture solution, a chemical, or the like and a variation in the culture state of the specimen can be suppressed, and the erroneous determination risk of the inspection result can be reduced.

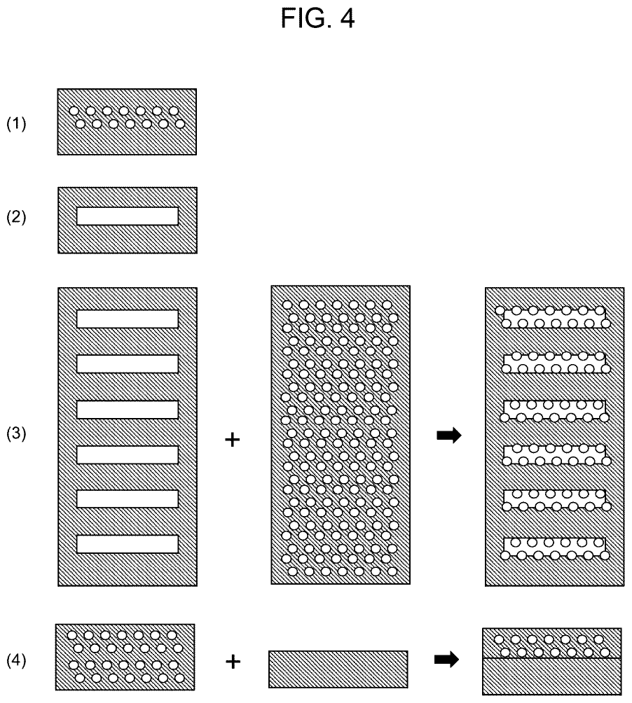

FIG. 4 illustrates another configuration example of the air volume adjusting material 2106. The air volume adjusting material 2106 may include a circular punched metal or a mesh-shaped portion. As long as an opening ratio can be controlled, the air volume adjusting material 2106 may be a continuous porous body or may be a material cut in a honeycomb structure, a quadrangular shape, or the like. Regarding the air volumes supplied to the upper portion and the lower portion of the plate in each of the stages, it is desirable that the lower portion in each of the stages has no or a small number of holes such that the air volume of the upper portion>the air volume of the lower portion≥0 is satisfied within a range where the temperature of the specimen container lid 2109>the temperature of the specimen container lower portion 2108 described above is satisfied. The air volume adjusting materials 2106 in the respective stages may have the same shape or different shapes depending each of the stages. In addition, in order to adjust the air volume, a member having one hole and a member having another hole may be combined. That is, the size/the number/a combination of arrangement of openings may be adjusted such that the air volume of a region above the specimen container lid 2109 is more than the air volume of a region below the specimen container lid 2109.

In FIG. 2, the temperature control section 2002 is disposed in the housing section upper portion to efficiently supply the warm air to the upper surface of the specimen container 0007 in each of the stages. Instead of providing the temperature control section 2002, the temperature control section 0006 may also function as the temperature control section 2002. When both of the temperature control section 2002 and the temperature control section 0006 are used, the temperature of the temperature control section 2002 is controlled such that the temperature in the device in the vicinity of the housing section 0003 (the transport section 0004)<the temperature of the outlet 2111 is satisfied.

### First Embodiment: Summary

The analysis device 0001 according to the present embodiment includes the air volume adjusting material 2106 such that the warm air for making the temperature of the specimen container lid 2109 higher than the temperature of the specimen container lower portion 2108 is uniformly supplied to each of the specimen container housing chambers 2003. As a result, while using the simple configuration, the effect of suppressing dew condensation in each of the housing chambers can be made uniform. Accordingly, a variation in the measurement result in each of the housing chambers can be suppressed. In addition, the plurality of specimen containers 0007 can be accommodated and cultured, and improvement in the processing capacity of the device and a reduction in the burden of the user can be implemented. Further, by disposing the specimen containers 0007 together in the housing section 0003, the device size can be reduced.

### Second Embodiment

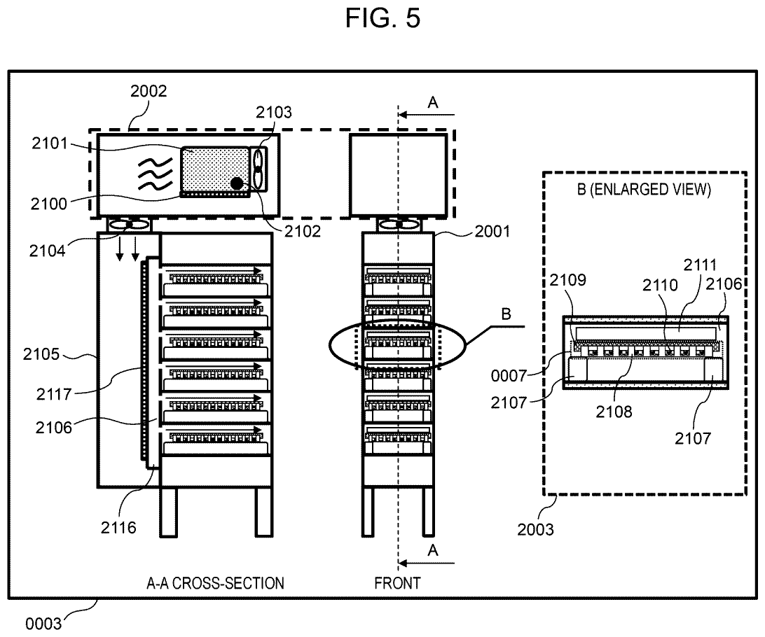

FIG. 5 illustrates a configuration example of the housing section 0003 in the analysis device 0001 according to a second embodiment of the present invention. In the configuration example illustrated in FIG. 5, the duct 2116 is provided in the duct 2105. An air volume adjusting material 2117 is disposed on a boundary surface between the duct 2105 and the duct 2116. In an inlet portion of the housing chamber in each of the stages, the air volume adjusting material 2106 is disposed as in the first embodiment. The air volume adjusting materials 2106 and 2117 may have the same configuration or may have different opening ratios (for example, the air volume adjusting material 2117 has a higher opening ratio). Other configurations are the same as those of the first embodiment.

The duct 2116 has an action of adjusting a pressure of the warm air. By providing the duct 2116, the influence of an axial flow of the fan 2104 can be suppressed, and a flow rate from the outlet 2111 can be uniformized across the upper stage to the lower stage. As a result, the amount of evaporation of the specimen 2110 in the specimen container 0007 can be fixed across the upper stage to the lower stage, and dew condensation can also be prevented.

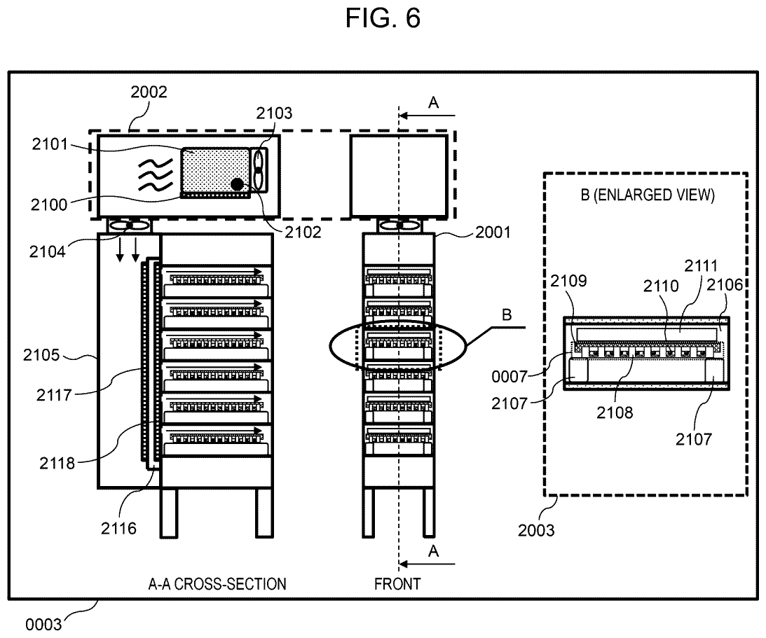

FIG. 6 illustrates another configuration example of the housing section 0003. In the configuration example illustrated in FIG. 6, in addition to the configuration described with reference to FIG. 5, an air volume adjusting material 2118 is provided on a boundary surface between the duct 2116 and the outlet 2111. Other configurations are the same as those of the first embodiment. By satisfying an opening ratio of the air volume adjusting material 2118<an opening ratio of the air volume adjusting material 2117, a flow rate of the air supplied from the outlet 2111 can be made more uniform across the upper stage to the lower stage as compared to FIG. 5.

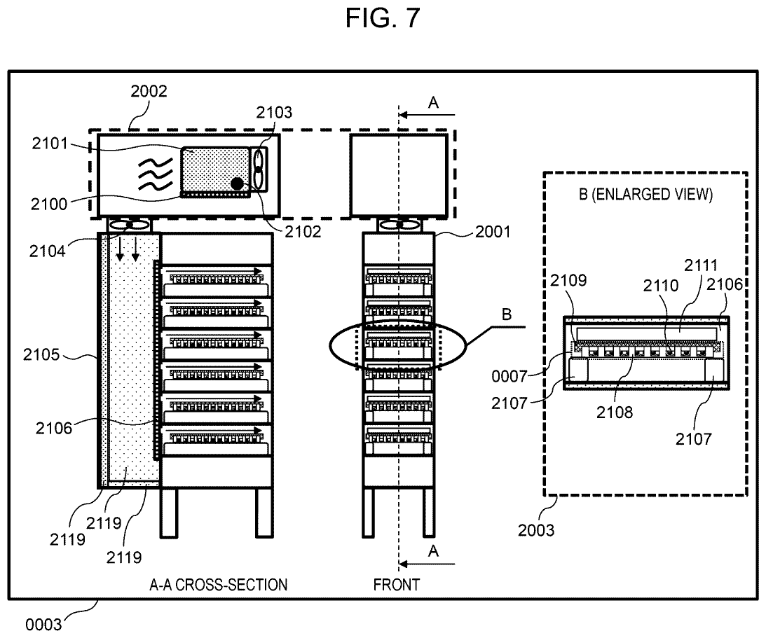

FIG. 7 illustrates another configuration example of the housing section 0003. In the configuration example illustrated in FIG. 7, the heat insulating material 2119 is attached to at least a part of an inner surface of the duct 2105 (and/or at least a part of an outer surface of the duct 2105). As a result, robustness to the temperature from the outside of the housing unit 2001 is improved. Other configurations are the same as those of the first embodiment. With the present structure, the warm air from the temperature control section 2002 where heat quantity loss is minimized can be supplied from the outlet 2111 to the specimen container lid 2109. The present structure may be combined with the heat insulating material 2119 in the structure of FIG. 5 or 6.

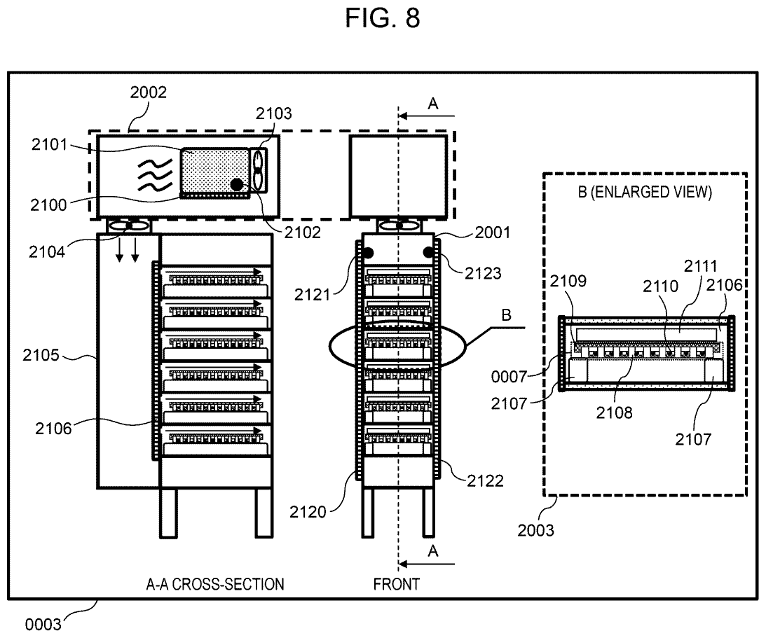

FIG. 8 illustrates another configuration example of the housing section 0003. In the configuration example illustrated in FIG. 8, a heat source 2120, a temperature sensor 2121 for controlling the temperature of the heat source 2120, a heat source 2122, and a temperature sensor 2123 for controlling the temperature of the heat source 2122 are provided on left and right side surfaces of the specimen container housing chamber 2003. As the heat sources 2120 and 2122, a heater, a Peltier element, or the like is used. Other configurations are the same as those of the first embodiment. This configuration may be combined with the configurations of FIGS. 5 to 7. The side surfaces described herein refer to at least surfaces that are not orthogonal to a path where the warm air passes through the inside of the specimen container housing chamber 2003.

For example, when the specimen 2110 is bacteria, the specimen container 0007 that is kept warm in the housing section 0003 needs to be kept warm at about 35° C. +1° C. for culturing the specimen 2110. The heat source 2120 and the heat source 2122 assist heating and are used for increasing the temperature control accuracy. In order to suppress dew condensation, controlled temperatures of the heat source 2120 and the heat source 2122<a controlled temperature of the heat source 2100 is satisfied, and the temperature of the warm air blown to the upper portion of the specimen container lid 2109 is set to be higher than a warming temperature of the specimen container 0007. For example, when the specimen 2110 is bacteria, there are bacterial species where growth is affected at 36° C. or higher and culture is delayed at 34° C. or lower. With the present configuration, the temperatures of the temperature control section 0006 and the temperature control section 2002 can be controlled such that the temperature of the housing unit 2001 is a temperature (for example, 35±1° C.) that does not affect the culture of the specimen 2110.

It is preferable that positions of the temperature sensors 2121 and 2123 are positions where a temperature of the specimen container 0007 or a space in the vicinity thereof can be relatively measured. In addition, as long as the correlation with the temperature of the specimen container lower portion 2108 in the housing section 0003 can be obtained, the temperature sensors 2121 and 2123 may be positioned at any position. The temperature sensors 2121 and 2123 may be positioned on a metal surface in the specimen container housing chamber 2003 or on cover surfaces of the heat source 2120 and 2122. That is, the positions of the temperature sensors 2121 and 2123 are not limited as long as the temperature of the specimen 2110 can be directly or indirectly measured.

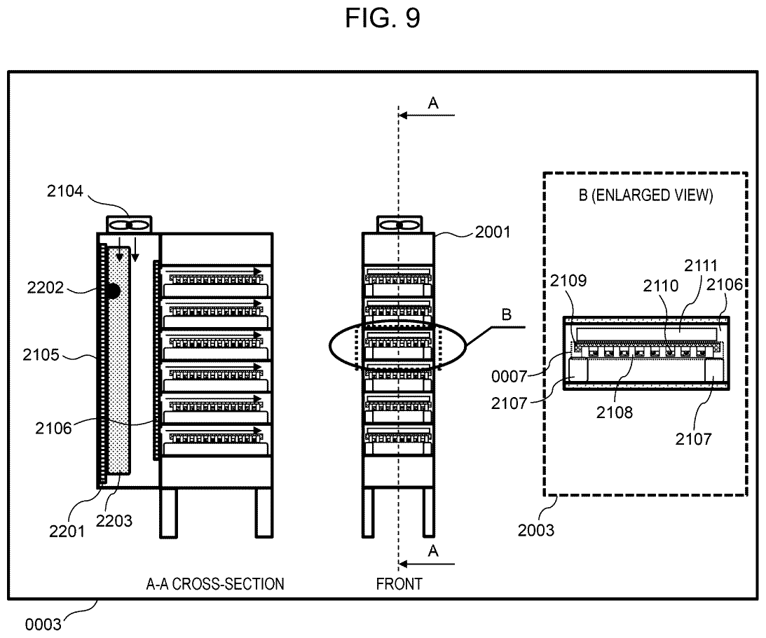

FIG. 9 illustrates another configuration example of the housing section 0003. In the configuration example illustrated in FIG. 9, instead of providing the temperature control section 2002 described with reference to FIG. 2, a heat source 2201, a heat sink 2203, and a temperature sensor 2202 are provided in the duct 2105. The kinds, materials, and the like of the heat source 2201 and the heat sink 2203 may be the same as those of the heat source 2100 and the heat sink 2101. The temperature of the heat source 2201 is controlled by the temperature sensor 2202 attached to the heat sink 2203. The heat source 2201 and the heat sink 2203 may be formed across one end to another end of arrangement of the specimen container housing chambers 2003. With the present structure, even when a plurality of housing units 2001 are present, the stable warm air can be supplied from the outlet 2111.

In the structures of FIGS. 5 to 8, the heat source and the like may be disposed in the duct 2105 as in FIG. 9. In this case, however, the temperature of the heat source 2201 is controlled such that the temperature in the vicinity of the transport section 0004 by the temperature control section 0006<the temperature of the outlet 2111 is satisfied. The heat insulating material 2119 is attached to a surface to which the heat source 2201 is not attached. Controlled temperatures of the heat source 2120 and the heat source 2122<a controlled temperature of the heat source 2201 is satisfied. The controlled temperature of the heat source 2201 is controlled such that the temperature of the housing unit 2001 is a temperature (for example, 35±1° C.) that does not affect the culture of the specimen 2110.

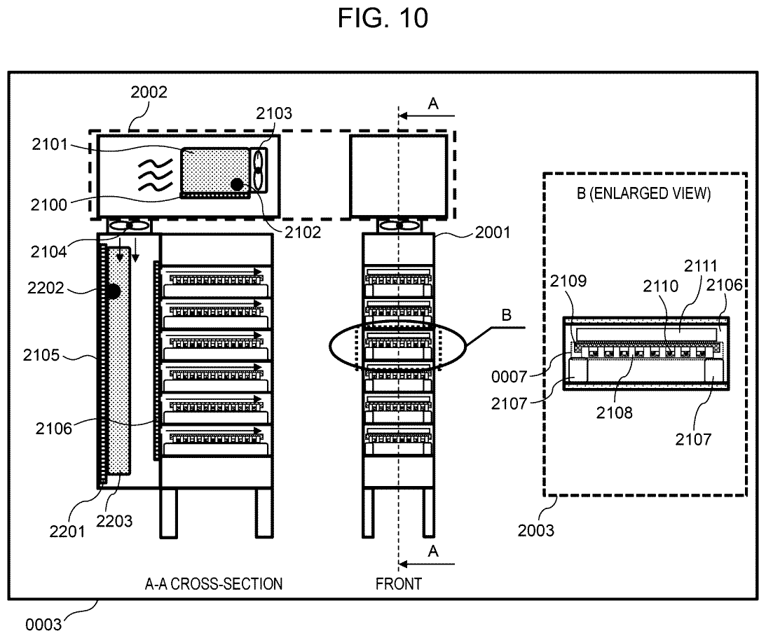

FIG. 10 illustrates another configuration example of the housing section 0003. The present structure is an example where the above-described configuration examples are combined. In the configuration example of FIG. 10, the temperature control section 2002 preheats the warm air, and the heat source 2201 in the duct 2105 heats the warm air to a designated temperature.

### Third Embodiment

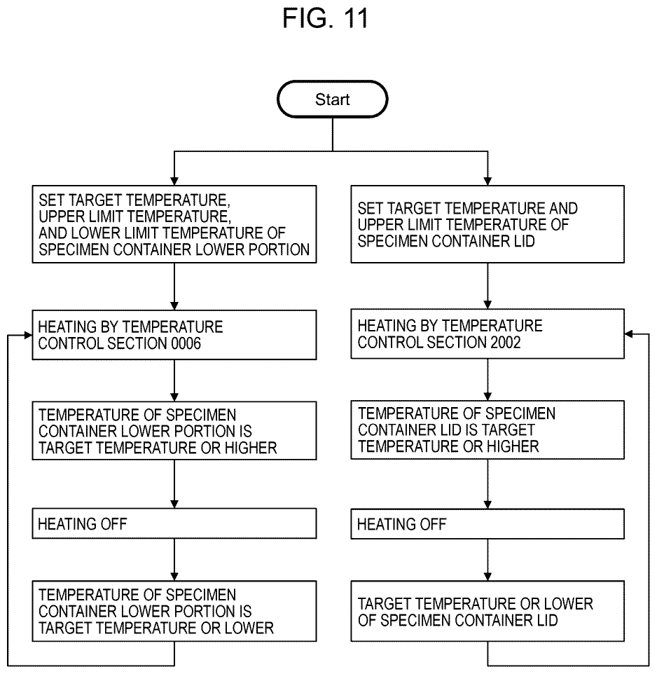

FIG. 11 is a flowchart illustrating a procedure where the arithmetic section 11 controls a temperature of each of sections in the analysis device 0001. The present flowchart can be used in the configuration of any of FIGS. 2, 5 to 7, and 9. The present flowchart is executed by the arithmetic section 11 controlling each of the temperature control sections.

The temperature control (the left half part of the flowchart) of the entire analysis device 0001 by the temperature control section 0006 and the temperature control (the right half part of the flowchart) by the temperature control section 2002 can be simultaneously executed. The temperature control by the temperature control section 0006 is the temperature control of the entire device, in particular, mainly the temperature control of the specimen container lower portion 2108 (specimen) in the housing section 0003. The temperature control by the temperature control section 2002 is the temperature control for suppressing occurrence of dew condensation of the lid using the temperature control of the specimen container lid 2109.

In the temperature control procedure of the entire device, a target temperature (target temperature of the specimen), an upper limit temperature, and a lower limit temperature of the specimen container lower portion 2108 in the housing section 0003 are set, and the specimen container lower portion 2108 is heated by the temperature control section 0006. The upper limit temperature or the lower limit temperature may be set based on the upper limit or the lower limit of the temperature that affects the growth or reaction of the specimen, or may be set depending on measurement conditions of the specimen measurement determined by a measurer. The upper limit temperature and the lower limit temperature may be set as an allowable temperature range. The upper limit temperature and the lower limit temperature do not need to be set as an allowable temperature range.

In the heating procedure by the temperature control section 0006, when the temperature of the specimen container lower portion 2108 is the target temperature or higher, the heating is turned off. Note that, after turning off the heating, overshoot is set to be lower than the upper limit temperature, and undershoot is set to be the lower limit temperature or higher. Further, when the temperature of the specimen container lower portion 2108 is the target temperature or lower, the specimen container lower portion 2108 is heated by the temperature control section 0006. Instead of measuring the temperature of the specimen container lower portion 2108 itself, the temperature in the vicinity of the specimen container lower portion 2108 where the correlation can be obtained may be measured. That is, the configuration is not limited as long as the temperature of the specimen container lower portion 2108 can be directly or indirectly measured.

In the temperature control of the specimen container lid 2109, a target temperature (higher than the target temperature of the specimen container lower portion 2108) and an upper limit temperature of the specimen container lid 2109 are set, and the specimen container lid 2109 is heated by the temperature control section 2002. The lower limit temperature of the specimen container lid 2109 is set such that the temperature of the specimen container lid 2109 can be controlled to be higher than the temperature of the specimen container lower portion 2108. That is, the lower limit temperature of the specimen container lid 2109 is not limited as long as the temperature of the specimen container lid 2109>the temperature of the specimen container lower portion 2108 can be reliably implemented.

In the heating procedure by the temperature control section 2002, when the temperature of the specimen container lid 2109 is the target temperature or higher, the heating is turned off. Note that, after turning off the heating, overshoot is set to be the upper limit temperature or lower, and undershoot is set to fall within a temperature range of the lower limit temperature or higher. Further, when the temperature of the specimen container lid 2109 is the target temperature or lower, the specimen container lid 2109 is heated by the temperature control section 2002. When the temperature of the specimen container lower portion 2108 is likely to be higher than the temperature of the specimen container lid 2109 depending on the set temperature, the heating by the temperature control section 2002 needs to be controlled such that the temperature of the specimen container lid 2109>the temperature of the specimen container lower portion 2108 is satisfied. Instead of measuring the temperature of the specimen container lid 2109 itself, the temperature in the vicinity of the specimen container lid 2109 where the correlation can be obtained may be measured. That is, the configuration is not limited as long as the temperature of the specimen container lid 2109 can be directly or indirectly measured.

A setting example of each of the temperatures is set, for example, as follows: the target temperature, the upper limit temperature, and the lower limit temperature of the specimen container lower portion 2108 are 35.0° C., 35.3° C., and 34.5° C., respectively; and the target temperature, the upper limit temperature, and the lower limit temperature of the specimen container lid 2109 are 35.6° C., 36.0° C., and 35.3° C., respectively.

The lower limit temperature of the specimen container lower portion 2108 can be used, for example, for determining control parameters. For example, when one interval of one loop cycle of the left side of FIG. 11 is determined, the lower limit temperature of the specimen container lower portion 2108 may be used as a reference.

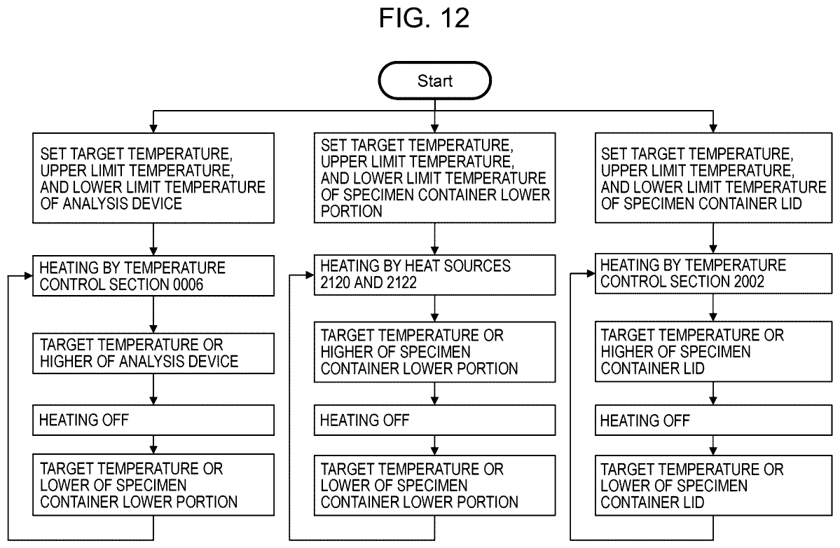

FIG. 12 is a flowchart illustrating a procedure where the arithmetic section 11 controls the temperature of each of sections in the analysis device 0001. The present flowchart can be used in the configuration of FIG. 8. The present flowchart is executed by the arithmetic section 11 controlling each of the temperature control sections.

The temperature control (the left of FIG. 12) of the entire analysis device 0001 by the temperature control section 0006, the temperature control (the center of FIG. 12) of the heat sources 2120 and 2122, and the temperature control (the right of FIG. 12) by the temperature control section 2002 can be simultaneously executed. The temperature control by the temperature control section 0006 can be mainly the temperature control of the entire analysis device 0001. The temperature control by the heat sources 2120 and 2122 is mainly the temperature control of the specimen container lower portion 2108 (specimen) in the housing section 0003. The temperature control by the temperature control section 2002 is mainly the temperature control for suppressing occurrence of dew condensation of the lid using the temperature control of the specimen container lid 2109. By executing the temperature control as described above, a higher temperature control accuracy can be implemented as compared to the temperature control of FIG. 11.

In the temperature control procedure of the entire device, a target temperature, an upper limit temperature, and a lower limit temperature of the analysis device 0001 are set, and the analysis device 0001 is heated by the temperature control section 0006. In order to suppress occurrence of dew condensation caused by a decrease in the temperature of the specimen container 0007 when the specimen container 0007 is unloaded from the housing section 0003, the device is reheated by the temperature control section 0006 when the device temperature is the lower limit temperature or lower of the specimen container lower portion 2018.

The temperature control of the specimen container lower portion 2108 is mainly for growing the specimen. A target temperature (target temperature of the specimen), an upper limit temperature, and a lower limit temperature of the specimen container lower portion 2108 are set, and the specimen container lower portion 2108 is heated by the heat sources 2120 and 2122. The upper limit temperature or the lower limit temperature may be set based on the upper limit or the lower limit of the temperature that affects the growth of the specimen, or may be set depending on measurement conditions of the specimen measurement determined by a measurer. The upper limit temperature and the lower limit temperature may be set as an allowable temperature range. The temperature set in the analysis device may be the same as or different from the temperature set regarding the specimen container lower portion 2108.

In the temperature control of the specimen container lid 2109, a target temperature (higher than the target temperature of the specimen container lower portion and the target temperature of the analysis device) and an upper limit temperature of the specimen container lid 2109 are set, and the specimen container lid 2109 is heated by the temperature control section 2002. The lower limit temperature of the specimen container lid 2109 is set such that the temperature of the specimen container lid 2109 can be controlled to be higher than the temperature of the specimen container lower portion 2108. That is, the lower limit temperature of the specimen container lid 2109 is not limited as long as the temperature of the specimen container lid 2109>the temperature of the specimen container lower portion 2108 can be reliably implemented.

In the heating procedure by the temperature control section 0006, when the temperature of the analysis device 0001 is the target temperature or higher, the heating is turned off. When the temperature of the analysis device 0001 is the lower limit temperature or lower of the specimen container lower portion 2108, the analysis device 0001 is heated by the temperature control section 0006. In consideration of the influence of the internal temperature of the device when the specimen is transported or measured, a heating setting when the lower limit temperature or lower of the specimen container lower portion 2108 is reached is preferable. When a temperature effect during the transport or measurement of the specimen is not considered, the analysis device 0001 may be heated to be the target temperature or lower. Accordingly, depending on condition settings of the user, the step on the left side of the lowermost stage of FIG. 12 may be “the lower limit temperature or lower of the specimen container lower portion” or may be “the target temperature or lower of the analysis device”.

In the heating procedure by the heat sources 2120 and 2122, when the temperature of the specimen container lower portion 2108 is the target temperature or higher, the heating is turned off. Note that, after turning off the heating, overshoot is set to be lower than the upper limit temperature, and undershoot is set to be the lower limit temperature or higher. Further, when the temperature of the specimen container lower portion 2108 is the target temperature or lower, the specimen container lower portion 2108 is heated by the heat sources 2120 and 2122. Since the heat source is positioned in the vicinity of the specimen container lower portion 2108, a temperature change can be adjusted with high accuracy. Accordingly, the temperature control can be executed in consideration of a temperature effect of the temperature control section 0006 or a temperature effect of the temperature control section 2002.

In the heating procedure by the temperature control section 2002, when the specimen container lid 2109 is heated to the target temperature or higher, the heating is turned off. Note that, after turning off the heating, overshoot is controlled to be the upper limit temperature or lower, and undershoot is controlled to fall within a temperature range of the lower limit temperature or higher. Further, when the temperature of the specimen container lid 2109 is the target temperature or lower, the specimen container lid 2109 is heated by the temperature control section 2002. When the temperature of the specimen container lower portion 2108 is higher than the temperature of the specimen container lid 2109 depending on the set temperature, the heating by the temperature control section 2002 needs to be controlled such that the temperature of the specimen container lid 2109>the temperature of the specimen container lower portion 2108 is satisfied.

A setting example of each of the temperatures is set, for example, as follows: the target temperature, the upper limit temperature, and the lower limit temperature of the analysis device 0001 are 35.0° C., 35.3° C., and 34.5° C., respectively; the target temperature, the upper limit temperature, and the lower limit temperature of the specimen container lower portion 2108 are 35.0° C., 35.3° C., and 34.5° C., respectively; and the target temperature, the upper limit temperature, and the lower limit temperature of the specimen container lid 2109 are 35.6° C., 36.0° C., and 35.3° C., respectively.

### Regarding Modification Example of Present Invention

The present invention is not limited to the embodiments and includes various modification examples. For example, the embodiments have been described in detail in order to easily describe the present invention, and the present invention is not necessarily to include all the configurations described above. In addition, a part of the configuration of one embodiment can be replaced with the configuration of another embodiment. Further, the configuration of one embodiment can be added to the configuration of another embodiment. In addition, addition, deletion, and replacement of another configuration can be made for a part of the configuration of each of the embodiments.

In the above-described embodiments, the outlet 2111 is configured by forming an opening in the entire surface of the specimen container housing chamber 2003, and the size and position of the opening of the air volume adjusting material (2106 or the like) are adjusted. As a result, the temperature of the specimen container lid 2109 can be set to be higher than the temperature of the specimen container lower portion 2108. That is, by combining the outlet 2111 and the air volume adjusting material (2106 or the like), the same effect as that of the above-described embodiments can be exhibited.

In the above-described embodiments, the arithmetic section 11 may present the temperature measured by each of the temperature sensors, the air volume (and/or air pressure) of each of the units, and the like on the monitor 13. Other information useful to the user may also be presented.

In the above-described embodiments, the arithmetic section 11 can also be configured by hardware such as a circuit device that implements the function or can also be configured by an arithmetic device such as a central processing unit (CPU) executing software that implements the function.

### REFERENCE SIGNS LIST

0001: analysis device
0002: loading/unloading section
0003: housing section
0004: transport section
0005: detection section
0006: temperature control section
0007: specimen container
1001: actuator
1002: actuator
1003: specimen container holding section
1004: measurement unit
1005: measurement section
1006: heat source
1007: heat sink
1008: fan
1009: temperature sensor
2001: housing unit
2002: temperature control section
2003: specimen container housing chamber
2100: heat source
2101: heat sink
2102: temperature sensor
2103: fan
2104: fan
2105: duct
2106: air volume adjusting material
2107: heat insulating material
2108: specimen container lower portion
2109: specimen container lid
2110: specimen
2111: outlet
2112: metal material
2113: metal material
2114: metal material
2115: metal material
2116: duct
2117: air volume adjusting material
2118: air volume adjusting material
2119: heat insulating material
2120: heat source
2121: temperature sensor
2122: heat source
2123: temperature sensor
2201: heat source
2202: temperature sensor
2203: heat sink

1. A specimen analysis device that analyzes a specimen, the specimen analysis device comprising:
a housing section configured to house a specimen container accommodating the specimen;
a temperature control section configured to generate warm air;
a first duct through which the warm air passes;
an outlet from which the warm air passing through the first duct is supplied to the housing section; and
a first air volume adjusting material configured to adjust an air volume of the warm air that is supplied to the housing section from the outlet,
wherein in the housing section, two or more housing chambers each of which houses the specimen container are disposed adjacent to each other,
the outlet is configured with two or more openings from which the warm air is supplied to each of the housing chambers, and
the first air volume adjusting material is configured to uniformize the air volume of the warm air supplied from each of the openings.

2. The specimen analysis device according to claim 1,
wherein the specimen container includes a specimen container lower portion and a specimen container lid that covers an upper surface of the specimen container lower portion, and
the outlet is configured such that the warm air passes through a region above the specimen container lid.

3. The specimen analysis device according to claim 2,
wherein the outlet is configured to satisfy at least one of
a condition that the warm air is introduced into the housing chamber from a position above the specimen container lid,
or
a condition that an air volume of the warm air passing through a region above the specimen container lid is more than an air volume of the warm air passing through a region below the specimen container lid.

4. The specimen analysis device according to claim 2,
wherein the opening is configured to satisfy at least one of
a condition that the opening is provided only at a portion above the specimen container lid in an inlet surface where the warm air is introduced into the housing chamber,
or
a condition that a total area of the opening that is provided at the portion above the specimen container lid in the inlet surface where the warm air is introduced into the housing chamber is more than a total area of the opening that is provided at a portion below the specimen container lid.

5. The specimen analysis device according to claim 1,
wherein the temperature control section is configured with one of
a first temperature control device configured to supply the warm air to the housing section by supplying the warm air into a housing of the specimen analysis device,
or
a second temperature control device configured to supply the warm air to the housing section, the second temperature control device being provided separately from the device that supplies the warm air into the housing of the specimen analysis device.

6. The specimen analysis device according to claim 1, further comprising:
a second duct configured to adjust a pressure of the warm air supplied to the housing section through the first duct; and
a second air volume adjusting material configured to adjust an air volume of the warm air, the second air volume adjusting material being disposed between the first duct and the second duct.

7. The specimen analysis device according to claim 6,
wherein an opening ratio of the first air volume adjusting material is different from an opening ratio of the second air volume adjusting material.

8. The specimen analysis device according to claim 6, further comprising a third air volume adjusting material configured to adjust an air volume of the warm air, the third air volume adjusting material being disposed between the second duct and the outlet,
wherein an opening ratio of the second air volume adjusting material is more than an opening ratio of the third air volume adjusting material.

9. The specimen analysis device according to claim 1,
wherein at least a part of an inner surface of the first duct or at least a part of an outer surface of the first duct is covered with a heat insulating material.

10. The specimen analysis device according to claim 1,
wherein the temperature control section includes a first heat source configured to heat the warm air,
the housing section includes a second heat source and a temperature sensor on a side surface that is not orthogonal to a direction in which the warm air is introduced from the outlet, the temperature sensor being configured to measure a temperature of the second heat source, and
a controlled temperature of the first heat source is higher than a controlled temperature of the second heat source.

11. The specimen analysis device according to claim 1, further comprising an air flow generating device configured to generate an air flow flowing through each of the housing chambers in the first duct,
the temperature control section includes a first heat source, and
the first heat source is disposed in the first duct and is configured to generate the warm air by heating the air flow.

12. The specimen analysis device according to claim 11,
wherein the temperature control section includes a second heat source,
the second heat source is disposed outside the first duct and is configured to supply warm air heated to a first temperature to the air flow generating device, and
the first heat source heats the air flow to a second temperature higher than the first temperature.

13. The specimen analysis device according to claim 2,
wherein the temperature control section includes
a first temperature control device configured to control a temperature of the specimen container lower portion by supplying warm air into a housing of the specimen analysis device, and
a second temperature control device configured to control a temperature of the specimen container lid by supplying the warm air to the housing section,
the specimen analysis device further includes an arithmetic section configured to control the temperature control section, and
the arithmetic section controls the temperature control section such that the temperature of the specimen container lid is higher than the temperature of the specimen container lower portion.

14. The specimen analysis device according to claim 10,
wherein the specimen container includes a specimen container lower portion and a specimen container lid that covers an upper surface of the specimen container lower portion,
the temperature control section includes
a first temperature control device configured to control a temperature of the specimen container lower portion by supplying warm air into a housing of the specimen analysis device, and
a second temperature control device configured to control a temperature of the specimen container lid by supplying the warm air to the housing section using the first heat source,
the specimen analysis device further includes an arithmetic section configured to control the temperature control section and the second heat source, and
the arithmetic section controls the temperature control section and the second heat source such that the temperature of the specimen container lid is higher than the temperature of the specimen container lower portion.
